(19) United States
(12) Patent Application Publication
(10) Pub. No.: US 2025/0230322 A1
(43) Pub. Date: Jul. 17, 2025

(54) High refractive index composition for coating of optical substrates and the use thereof

(71) Applicant: Inkron Oy, Espoo (FI)

(72) Inventors: Jarkko Heikkinen, Espoo (FI); Mikko Poutanen, Espoo (FI); Tia Asikainen, Espoo (FI); Juha Jääskeläinen, Espoo (FI)

(21) Appl. No.: 18/730,827

(22) PCT Filed: Jan. 23, 2023
(86) PCT No.: PCT/FI2023/050049

§ 371 Date: Jul. 22, 2024

(30) Foreign Application Priority Data
Jan. 24, 2022 (FI) 20225053

(51) Int. Cl. C09D 5/00; C09D 7/40; C09D 7/61; C09D 133/10; C09D 183/04; G02B 1/10

(52) U.S. Cl. CPC C09D 5/006; C09D 7/61; C09D 7/67; C09D 133/10; C09D 183/04; G02B 1/10

(57) ABSTRACT

Black coatings on optical substrates, compositions for producing such coatings and the use of the compositions for edge-blackening and stray light control. The present coatings comprise a film formed by a curable composition mixed with nanoparticles and black pigment, wherein the film has a refractive index of more than 1.75. The present cured compositions comprise 0 to 50 parts by weight of a curable polymers; 0 to 50 parts by weight of curable monomers; 50 to 100 parts by weight of nanoparticles; and 0.1 to 20 parts by weight of black pigment, and the nanoparticles and black pigment are mixed with the curable polymers and monomers. The present compositions exhibit RI values which match that of high-RI glass substrates while providing efficient edge-blackening properties.

### FIELD OF THE INVENTION

The present invention relates to coating of optical substrates using curable compositions containing fillers. More specifically, the present invention concerns black coatings on optical substrates, compositions for producing such coatings and the use of the compositions for edge-blackening and stray light control.

### BACKGROUND

Edge-blackening coatings are applied on edges of optical substrates, or at specific limited locations of the optical substrates, specifically on substrates where light propagates inside the substrate. Typically, the coating is applied on optical components such as lenses, prisms, beam splitters, waveguides or diffractive optical elements to minimize undesired reflection of the light propagating inside the optical substrate from the substrate-air interfaces. Additionally, edge-blackening minimizes the light entering the optical substrate through the coated areas. The edge regions typically comprise non-polished rough surfaces. Light reflecting from the edges typically leads to stray light, which is a common limiting factor for the performance of the optical system.

The reflection of light arriving at substrate-air interface can be minimized by applying an edge-blackening coating, and for optimal performance, the coating needs to minimize the three effects depicted in FIG. 1. These are 1) reflection at the substrate-coating interface, 2) entering of light to the substrate from within the optical coating either due to reflection at coating-air interface or light entering the coating from outside, and 3) re-entering the optical substrate due to scattering within the optical coating.

To achieve a proper reduction of reflection at the substrate-coating interface (component 1, FIG. 1), the material used for coating should have a refractive index, more specifically the real part of the complex refractive index, which matches that of the substrate. Traditional edge-blackening coatings do not, however, have high refractive indices and therefore they do not perform well on high refractive index (RI) substrates. The k-value, i.e. the complex part of the RI, is always non-zero in black materials, i.e. absorbing materials, and it partly contributes to the reflectance. The optical substrates are typically highly transparent to the desired wavelength of light, which indicates k-value is close to zero. As an example, at normal incidence, the reflectance, R, at the interface of a transparent substrate and absorbing coating is depicted by the following equation:

$$R = \frac{{( {n}_{s} - {n}_{c} )}^{2} + {k}_{c}^{2}}{{( {n}_{s} + {n}_{c} )}^{2} + {k}_{c}^{2}} ,$$

Where nₛ and n_{c} are the real parts of the complex refractive indices for the substrate and coating, respectively, and k_{c} is the complex part of the refractive index of the coating. Even with matched real part of the RI, with high k-values (>0.05) of the coating, the reflectance due to the mismatch in k-value, will have a meaningful contribution to the component 1 of reflection.

Once the light has entered the optical coating, its re-entering (component 2, FIG. 1) to the optical substrate is prevented by the light absorbing properties of the material, that is the blackness of the material. The absorbance or optical density of the material at the desired wavelengths of light, typically wavelengths of visible light, should be high enough that only a minimal intensity of light re-enters from the black coating. Another re-entering mechanism is scattering in the edge-blackening coating (component 3, FIG. 1), causing diffuse reflection of the incoming light.

The refractive index is typically increased by utilizing high refractive index fillers. When increasing the refractive index to above 1.75, in particular above 1.80 at 589 nm, the required weight content of the filler particles is significant and unless the formulation is carefully balanced, that limits the use of the material due to high viscosity and poor coating properties.

### SUMMARY OF THE INVENTION

The present invention is based on the idea of providing a black coating, which comprises a film formed by curing a composition of curable polymer and curable monomers mixed with high refractive index nanoparticles and black pigment.

In one embodiment, a black coating comprises a film formed by a photo curable composition mixed with metal oxide nanoparticles and black pigment, the cured solid film has a metal oxide nanoparticle weight percentage greater than 45%, in particular greater than 50%.

A composition for forming coatings on optical substrates typically comprises
curable monomer(s);
optionally one or more curable polymers;
nanoparticles;
black pigment; and optionally
additives.

The nanoparticles, black pigment and any additives are typically mixed with the curable monomers and any curable polymers.

The compositions can be used for edge-blackening or stray light control of a high refractive index material. In particular, the compositions are useful for edge-blackening of high refractive index material comprising optical substrate.

More specifically, the present invention is characterized by what is stated in the independent claims.

Considerable advantages are obtained by the present invention.

The present compositions exhibit properties that minimize the reflection of light at an optical substrate—coating interface to provide efficient edge-blackening properties. These properties are RI values which match that of high RI glass substrates, adjustable optical density to absorb light within the coating at varying thicknesses while minimizing the reflection due to the k-value mismatch and minimizing re-entering of light by scattering.

Typically, the cured materials will have a high refractive index, for example, an RI of more than 1.75 or in the range of 1.80 to 2.3 as measured at 589 nm.

By the use of nanoparticles as fillers, the RI can be tailored to match those of various substrates. The optical density, i.e. the logarithm of base 10 of the reciprocal of transmittance, can be modified by the black pigment. The present resin compositions allow for the incorporation of more than 45% by weight of the composition of nanoparticles, in particular metal oxide nanoparticles.

The compositions can be provided in solvent free form to allow for solvent free products.

The viscosity can be adjusted by varying the composition, in particular the relative amounts of polymer(s) and monomer(s) or optionally by utilizing solvents to allow for application by various contacting and non-contact methods. The materials are typically cured by photo activation, in particular using UV light.

### BRIEF DESCRIPTION OF THE DRAWINGS

FIG. 1 shows phenomena how the high optical density black coating reduces light reflectance at the optical substrate—black coating interface;

FIG. 2 shows total reflectivities of glass-coating interfaces of different black filler formulations; and

FIG. 3 shows diffuse reflectivities of glass-coating interfaces of different black filler formulations

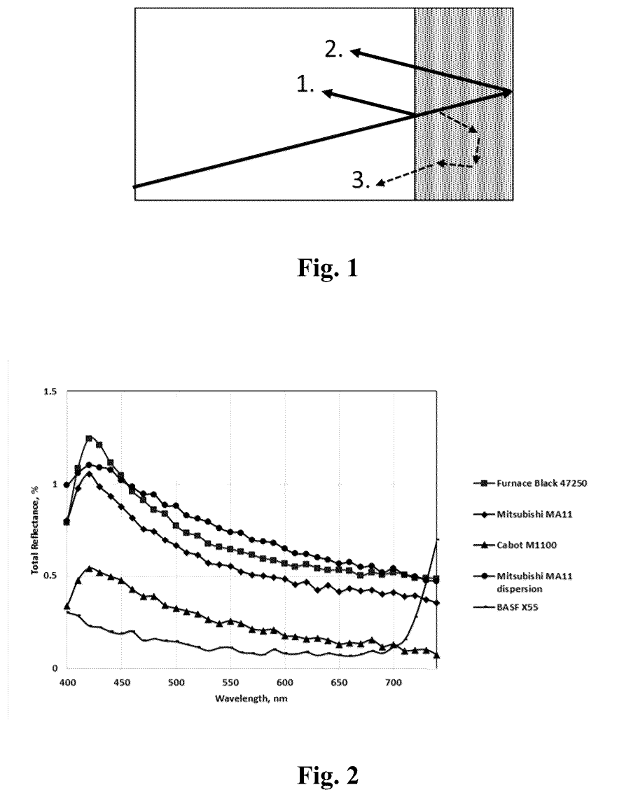

### EMBODIMENTS

It is noted that, as used herein, the singular forms of “a”, “an” and “the” include plural referents unless the context clearly dictates otherwise. It will be further understood that the term “comprises” and/or “comprising”, when used in this specification, specify the presence of stated features, steps, operations, elements, and/or components, but do not preclude the addition of one or more other features, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein Unless otherwise stated herein or clear from the context, any percentages referred to herein are expressed as percent by weight based on a total weight of the respective composition.

Unless otherwise stated, properties that have been experimentally measured or determined herein have been measured or determined at room temperature. Unless otherwise indicated, room temperature is 25° C.

As used herein, the term “about” refers to a value which is ±5% of the stated value.

Unless otherwise stated, properties that have been experimentally measured or determined herein have been measured or determined at atmospheric pressure.

As used herein, unless otherwise indicated, the term “average molecular weight” refers to a weight average molecular weight (also abbreviated “Mw” or “Mw”).

As used herein, the molecular weight has been measured by gel-permeation chromatography using polystyrene standards.

The “particle size” and “average particle size”, indicated herein, refers to the number average particle size based on a largest linear dimension of the particles (also referred to as “diameter”). It is determined by light scattering, in particular by dynamic light scattering. The reported average is the Z-average, i.e. the intensity weighted mean of the hydrodynamic diameter.

As used herein, the term “average particle size” refers to the D₅₀ value of the cumulative volume distribution curve at which 50% by volume of the particles have a diameter less than that value.

As used herein, unless otherwise stated, the term “viscosity” stands for dynamic viscosity, at 25° C., determined by a rheometer at a 2.5 s⁻¹ shear rate.

In the present context, the term “black pigment” stands for a pigment or a particle having an absorption coefficient in the range of visible light radiation, i.e. approximately between 380 to 740 nm, leading to a visually black appearance. For example, when the black pigment is present in a 50 μm thick coating at concentration of 4%, the coating will have optical density higher than 2.

In the present context, the term “black coating” stands for a coating which contains a black pigment and the coating has an optical density higher than 2, measured by spectrophotometer in the range of visible light radiation, that is approximately between 380 to 740 nm.

In the present context, “optical substrate” stands for a material, or a stack of materials which have high internal transmittance (higher than 90%), and typically low levels of attenuation (lower than 10%) due to scattering or luminescence at the used wavelengths of light, typically at visible wavelengths. In the present context, the optical substrate onto which the coating is applied has high refractive index, in particular, the refractive index of the optical substrate is on the order of 1.75 or more, in particular 1.8 or more, in particular about 1.8 to 2.5, typically 1.85 to 2.3 at the wavelength of 589 nm.

The optical substrate can comprise an amorphous material, such as glass, crystalline material such as a mineral crystalline material, polymeric material, or an optical coating comprising for example inorganic fillers embedded in a polymeric matrix. The optical substrate can be for example in the form of a wafer material and the optical substrates can be comprised of a single layer or they can comprise multilayer structures.

In one embodiment, the optical substrate is an optical glass, such as flint glass or crown glass. It may further contain additives, such as zinc oxide, boric oxide, barium oxide, fluorite or lead or combinations thereof.

Embodiments of the present technology provide high RI edge-blackening and/or stray light control materials.

Embodiments further provide formulations which can be applied onto an optical substrate, such as a glass wafer to achieve a black coating.

In embodiments, the present formulations comprise—or consist of or consist essentially of—a binder, such as a curable polymer, in particular a prepolymer with crosslinking groups, such as a siloxane polymer, curable monomers with cross-linking groups, such as acrylate groups, and the binder is mixed with nanoparticles, such as titanium dioxide, to adjust the refractive index (RI) to match that of the optical substrate, and a black pigment, such as soot or carbon black, to achieve high optical density.

In embodiment, the present black coatings comprise a film formed by a photo curable composition mixed with metal oxide nanoparticles and black pigment, and the cured solid film has a metal oxide nanoparticle percentage greater than 45%, in particular greater than 50%, for example 55 to 90%, or 55 to 80%, calculated from the weight of the film.

In one embodiment, the black coating comprises a film having a thickness of 1 to 300 μm. In one embodiment, the black coating comprises a film having a thickness of 5 to 100 μm, such as 10 to 50 μm. In one embodiment, the black coating comprises a film, which exhibits, at a film thickness of 50 μm, an optical density of more than 2 at wavelengths between 400 and 740 nm.

In one embodiment, the curable monomers are selected from compounds that includes crosslinking groups. Examples of such crosslinking groups are epoxy, glycidyl, vinyl, allyl, acrylate and methacrylate and combinations thereof.

The weight ratio between the curable polymer(s) and curable monomer(s) generally amounts to 1:100 to 100:1, for example 10:100 to 100:10, in particular 15 to 50 to 50:15.

In one embodiment, the nanoparticles are selected from non-absorbing metal oxide particles with a k-value lower than 0.05 at the visible wavelengths of light. Examples of such particles include titanium dioxide, zirconium dioxide, hafnium dioxide, germanium dioxide, aluminium oxide, barium titanate, niobium oxide and combinations thereof.

In one embodiment, the nanoparticles are selected from metal oxide particles, such as titanium dioxide and zirconium oxide.

In one embodiment, the nanoparticles have a Z-average particle size of 1 to 200 nm, in particular 2 to 100 nm.

The Z-average particle size of the nanoparticles influences, the viscosity and refractive index of the final formulation. Large-sized nanoparticles usually give higher refractive indexes and lower viscosities than smaller particle size nanoparticles. By controlling and adjusting the viscosity for example by selection of the particle size of the nanoparticles, the final formulation can be adapted to different application methods so as to give workable formulations.

In one embodiment, the nanoparticles are generally aggregate-free.

In one embodiment, nanoparticles are being used as coated nanoparticles, the coating being employed to prevent agglomeration of the particles. Typical coatings of the nanoparticles are different silane monomers like methacrylate propyl trimethoxysilane, hexyltrimethoxysilane, glycidoxypropyltrimethoxysilane or methyltrimethoxysilane to mention a few. The coating of nanoparticles can be also other oxide coatings like ZrO₂, Al₂O₃ or TiO₂ to further stabilize the nanoparticles against photocatalysis.

In one embodiment, the nanoparticles are provided as a never-dried dispersion.

In one embodiment, the weight ratio of nanoparticles to the curable composition, formed by curable polymer(s) and curable monomer(s), amounts to from 95:5 to 50:50, in particular from 90:10 to 50:50, for example from 85:15 to 50:50.

In one embodiment, the black pigment is selected from soot, carbon black, graphite, synthetic graphite, carbon nanotubes, metal complex dyes and metal oxide particles and combinations thereof. The black pigment can also comprise black organic pigments.

The concentration of the black pigment in the film is selected to be between 0.1 to 200%, such as 0.5 to 10%, calculated from the weight of the curable polymer and the nanoparticles, to adjust the optical density of the cured coating at the desired coating thickness.

The black pigment, for example carbon black, typically exhibits an average particle size of its primary particles of about 10 to 100 nm, whereas the secondary particles such as agglomerates have a particle size of about 1 to 100 μm. The black pigment is selected to minimize the scattering of light by the pigment and its secondary particles such as agglomerates.

In one embodiment, the composition comprises non-aggregated black pigments.

In one embodiment, the film is deposited on a glass wafer, in particular on a non-polished surface of a glass wafer.

In one embodiment, the film is deposited on an optical substrate or on a stack of optical substrates having a refractive index of more than 1.75, or more than 1.8, in particular 1.8 to 2.3, for example 1.80 to 2.1, at 589 nm. In one embodiment, the film has a refractive index of 1.80 to 2.05, or 1.90 to 2.1, or 1.95 to 2.1, at 589 nm.

The refractive index of the film deposited on the optical substrate corresponds to or is equal to that of the optical substrate. Thus, in one embodiment, the refractive index of the film differs no more than ±0.4 units, in particular no more than ±0.1 units, in particular no more than ±0.05 units, from that of the optical substrate at 589 nm.

In one embodiment, the film applied on a flat glass wafer exhibits a ratio of total to diffuse reflection of the reflectance at the optical substrate—coating interface greater than 10:1, in particular greater than 100:1, and typically up to 1000:1.

In one embodiment, the black pigment is selected to obtain black coating with diffuse reflectance lower than 1.5%, in particular lower than 1.0%.

The optical substrate typically has a thickness in the range of 100 μm to 10 000 μm, for example 300 to 1500 μm.

In one embodiment, the coating film has a thickness of 5 to 100 μm and it is deposited on an optical substrate having a thickness of 100 to 1500 μm.

In one embodiment, the total reflection at an interface between the optical substrate and the coating film is less than 2%, in particular less than 1.0% at 420-740 nm.

In one embodiment, the optical substrate comprising a black coating further comprises a sheet having edges defining the sheet, said black coating covering at least areas adjacent to said edges of said sheet.

Preferably, the sheet has a width, a length and an area, wherein the black coating covers no more than 50%, in particular no more than 25% of the total area of the sheet. In one embodiment, the black coating comprises an integral layer extending along the width and the length of the sheet covering 5 to 20% of the total area of the substrate adjacent to the edges of the sheet.

In one embodiment, a composition for coating of optical substrates, comprises, consists of or consists essentially of
up to 50 parts by weight of curable polymer(s);
up to 50 parts by weight of curable monomer(s);
50 to 100 parts, for example 55 to 90 parts or 55 to 85 parts, by weight of metal oxide nanoparticles; and
0.1 to 20 parts, in particular 0.5 to 10 parts, by weight of black pigment.

In the composition, the nanoparticles and black pigment are typically mixed, in particular evenly mixed, with the curable polymer.

In one embodiment, the composition contains always at least some curable monomers and optionally curable polymers.

In addition to the above components, the composition contains, in some embodiments, a solvent capable of least partially dissolving the curable polymer and optionally monomers. Typically, the solvent forms 0.1 to 50% of the total weight of the composition, for example 1 to 30% of the total weight of the composition.

In one embodiment, a composition for coating of optical substrates, comprises, consists of or consists essentially of a mixture of
up to 50 parts by weight of curable polymer(s);
up to 50 parts by weight of curable monomer(s);
50 to 100 parts, for example 55 to 90 parts or 55 to 85 parts, by weight of metal oxide nanoparticles;
0.1 to 20 parts, in particular 0.5 to 10 parts, by weight of black pigment; and
0.1 to 50% for example 1 to 30%, by weight of the composition of a liquid capable of least partially dissolving the curable polymer and optionally monomers.

In one embodiment, a composition comprising black pigment in a concentration of 0.1 to 10%, such as 0.5 to 6%, calculated from the total weight of the composition excluding any solvent.

In the above embodiments, there is further typically present 0.1 to 25%, for example 1 to 10%, calculated from the weight of the total composition, of a photopolymerization initiator or a combination of photopolymerization initiators, as will be explained below.

In one embodiment, a composition is provided in solvent free or essentially solvent free form. In particular, the composition comprises less than 5%, in particular less than 2%, of a solvent calculated from the total weight of the composition.

Compositions, both free from a solvent and containing a solvent, comprise, consist of or consist essentially of a mixture of 0 to 25 parts by weight, for example 1 to 15 parts by weight of a polymer or of polymers, and 5 to 50 parts by weight, for example 10 to 40 parts by weight of a monomer or a mixture of monomers, combined with 0.1 to 20 parts of black pigment. Typically, they further contain photopolymerization initiator(s) at 0.1 to 25%, for example 1 to 10%, calculated from the weight of the total composition.

In one embodiment, the curable polymer has a molecular weight (M_{w}) of 500 to 100 000 g/mol. Typically, the curable polymer exhibits reactive groups which will allow for cross-linking of the polymer during curing.

In one embodiment, the curable polymer comprises a siloxane polymer.

To make the siloxane polymer, a first compound is provided having a chemical formula SiR¹ₐR²₄₋ₐ where a is from 1 to 3, R¹ is a reactive group, and R² is an alkyl group or an aryl group. Also provided is a second compound that has the chemical formula SiR³_{b}R⁴_{c}R⁵_{4-(b+c)} where R³ is a cross-linking functional group, R⁴ is a reactive group, and R⁵ is an alkyl or aryl group, and where b=1 to 2, and c=1 to (4−b). An optional third compound is provided along with the first and second compounds, to be polymerized therewith. Also an optional fourth compound can be provided along with the first. second and third compounds, to be polymerized therewith. The third and fourth compounds may have the chemical formula SiR⁹_{f}R¹⁰_{g} where R⁹ is a reactive group and f=1 to 4, and where R¹⁰ is an alkyl or aryl group and g=4−f. If both third and fourth compounds are provided along with the first and second compounds, the third and fourth compounds are not identical. The first, second, third and fourth compounds may be provided in any sequence, and oligomeric partially polymerized versions of any of these compounds may be provided in place of the above-mentioned monomers.

The first, second, third and fourth compounds, and any compounds recited hereinbelow, if such compounds have more than one of a single type of “R” group such as a plurality of aryl or alkyl groups, or a plurality of reactive groups, or a plurality of cross-linking functional groups, etc., the multiple R groups are independently selected so as to be the same or different at each occurrence. For example, if the first compound is SiR¹₂R²₂, the multiple R¹ groups are independently selected so as to be the same or different from each other. Likewise, the multiple R² groups are independently selected so as to be the same or different from each other. The same is for any other compounds mentioned herein, unless explicitly stated otherwise.

A catalyst is also provided. The catalyst may be a base catalyst, or other catalyst as mentioned below. The catalyst provided should be capable of polymerizing the first and second compounds together. As mentioned above, the order of the addition of the compounds and catalyst may be in any desired order. The various components provided together are polymerized to create a siloxane polymeric material having a desired molecular weight and viscosity. After the polymerization, particles, such as microparticles, nanoparticles or other desired particles are added, along with other optional components such as coupling agents, catalyst, stabilizers, adhesion promoters, and the like. The combination of the components of the composition can be performed in any desired order.

More particularly, in one example, a siloxane polymer is made by polymerizing first and second compounds, where the first compound has the chemical formula I

SiR¹ₐR²₄₋ₐ I

wherein
a is an integer from 1 to 3,
R¹ is a reactive group, and
R² is an alkyl group or an aryl group,
and the second compound has the chemical formula II

SiR³_{b}R⁴_{c}R⁵_{4-(b+c)} II

wherein
R³ is a cross-linking functional group,
R⁴ is a reactive group, and
R⁵ is an alkyl or aryl group, and where
b is an integer 1 to 2, and c is an integer 1 to (4−b).

The first compound may have from 1 to 3 alkyl or aryl groups (R²) bound to the silicon in the compound. A combination of different alkyl groups, a combination of different aryl groups, or a combination of both alkyl and aryl groups is possible. If an alkyl group, the alkyl contains preferably 1 to 18, more preferably 1 to 14 and particularly preferred 1 to 12 carbon atoms. Shorter alkyl groups, such as from 1 to 6 carbons (e.g. from 2 to 6 carbon atoms) are envisioned. The alkyl group can be branched at the alpha or beta position with one or more, preferably two, C₁ to C₆ alkyl groups. In particular, the alkyl group is a lower alkyl containing 1 to 6 carbon atoms, which optionally bears 1 to 3 substituents selected from methyl and halogen. Methyl, ethyl, n-propyl, i-propyl, n-butyl, i-butyl and t-butyl, are particularly preferred. A cyclic alkyl group is also possible like cyclohexyl, adamantyl, norbornene or norbornyl.

If R² is an aryl group, the aryl group can be phenyl, which optionally bears 1 to 5 substituents selected from halogen, alkyl or alkenyl on the ring, or naphthyl, which optionally bear 1 to 11 substituents selected from halogen alkyl or alkenyl on the ring structure, the substituents being optionally fluorinated (including per-fluorinated or partially fluorinated). If the aryl group is a polyaromatic group, the polyaromatic group can be for example anthracene, naphthalene, phenanthere, tetracene which optionally can bear 1-8 substituents or can be also optionally ‘spaced’ from the silicon atom by alkyl, alkenyl, alkynyl or aryl groups containing 1-12 carbons. A single ring structure such as phenyl may also be spaced from the silicon atom in this way.

The siloxane polymer is made by performing a polymerization reaction, preferably a base catalyzed polymerization reaction between the first and second compounds. Optional additional compounds, as set forth below, can be included as part of the polymerization reaction.

The first compound can have any suitable reactive group R¹, such as a hydroxyl, halogen, alkoxy, carboxyl, amine or acyloxy group. If, for example, the reactive group in the first compound is an —OH group, more particular examples of the first compound can include silanediols such as diphenylsilanediol, dimethylsilanediol, di-isopropylsilanediol, di-n-propylsilanediol, di-n-butylsilanediol, di-t-butylsilanediol, di-isobutylsilanediol, phenylmethylsilanediol and dicyclohexylsilanediol among others.

The second compound can have any suitable reactive group R⁴, such as a hydroxyl, halogen, alkoxy, carboxyl, amine or acyloxy group, which can be the same as or different from the reactive group in the first compound. In one example, the reactive group is not —H in either the first or second compound (or any compounds that take part in the polymerization reaction to form the siloxane polymer—e.g. the third compound, etc.), such that the resulting siloxane polymer has an absence of any, or substantially any, H groups bonded directly to the Si in the siloxane polymer. Group R⁵, if present at all in the second compound, is independently an alkyl or aryl groups such as for group R² in the first compound. The alkyl or aryl group R⁵ can be the same or different from the group R² in the first compound.

The cross-linking reactive group R³ of the second compound can be any functional group that can be cross-linked by acid, base, radical or thermal catalyzed reactions. These functional groups can be for example any epoxide, oxetane, acrylate, alkenyl, alkynyl or thiol group.

If an epoxide group, it can be a cyclic ether with three ring atoms that can be cross-linked using acid, base and thermal catalyzed reactions. Examples of these epoxide containing cross-linking groups are glycidoxypropyl and (3,4-Epoxycyclohexyl)ethyl) groups to mention few

If an oxetane group, it can be a cyclic ether with four ring atoms that can be cross-linked using acid, base and thermal catalyzed reactions. Examples of such oxetane containing silanes include 3-(3-ethyl-3-oxetanylmethoxy)propyltriethoxysilane, 3-(3-Methyl-3-oxetanylmethoxy)propyltriethoxysilane, 3-(3-ethyl-3-oxetanylmethoxy)propyltrimethoxy-silane or 3-(3-Methyl-3-oxetanylmethoxy)propyltrimethoxysilane, to mention a few.

If an acrylate group, it can be an acrylate or methacrylate that can be cross-linked using radical initiators, which can be activated by either UV light or heat. Examples of such acrylate containing silanes are 3-(trimethoxysilyl)propylmethacrylate, 3-(trimethoxysilyl)propyl-acrylate, 3-(triethoxysilyl)propylmethacrylate, 3-(triethoxysilyl)propylacrylate, 3-(dimethoxymethylsilyl)propylmethacrylate or 3-(methoxydimethylsilyl)propyl-methacrylate, to mention a few.

If an alkenyl group, such a group may have preferably 2 to 18, more preferably 2 to 14 and particularly preferred 2 to 12 carbon atoms. The ethylenic, i.e. two carbon atoms bonded with double bond, group is preferably located at the position 2 or higher, related to the Si atom in the molecule. Branched alkenyl is preferably branched at the alpha or beta position with one and more, preferably two, C₁ to C₆ alkyl, alkenyl or alkynyl groups, optionally fluorinated or perfluorinated alkyl, alkenyl or alkynyl groups.

If an alkynyl group, it may have preferably 2 to 18, more preferably 2 to 14 and particularly preferred 2 to 12 carbon atoms. The ethylinic group, i.e. two carbon atoms bonded with triple bond, group is preferably located at the position 2 or higher, related to the Si or M atom in the molecule. Branched alkynyl is preferably branched at the alpha or beta position with one and more, preferably two, C₁ to C₆ alkyl, alkenyl or alkynyl groups, optionally per-fluorinated alkyl, alkenyl or alkynyl groups.

If a thiol group, it may be any organosulfur compound containing carbon-bonded sulfhydryl group. Examples of thiol containing silanes are 3-mercaptopropyltrimethoxysilane and 3-mercaptopropyltriethoxysilane.

The reactive group in the second compound can be an alkoxy group. The alkyl residue of the alkoxy groups can be linear or branched. Preferably, the alkoxy groups are comprised of lower alkoxy groups having 1 to 6 carbon atoms, such as methoxy, ethoxy, propoxy and t-butoxy groups. A particular example of the second compound is an silane, such as 2-(3,4-Epoxycyclohexyl)ethyltrimethoxysilane, 2-(3,4-epoxycyclohexyl)ethyltriethoxysilane, 3-(Trimethoxysilyl)propylmethacrylate, 3-(Trimethoxysilyl)propylacrylate, (3-glycidyloxypropyl)trimethoxysilane, or 3-glycidoxypropyltriethoxysilane, 3-methacryloxypropyltrimethoxysilane, 3-acryloxypropyltrimethoxysilane, among others.

A third and fourth compound may be provided along with the first and second compounds, to be polymerized therewith. The third and fourth compounds may independently have the chemical formula III

SiR⁹_{f}R¹⁰_{g} III

wherein
R⁹ is a reactive group and
f=1 to 4, and where
R¹⁰ is an alkyl or aryl group and
g=4−f.

One such example is tetramethoxysilane. Other examples include phenylmethyldimethoxysilane, trimethylmethoxysilane, dimethyldimethoxysilanesilane, vinyltrimethoxysilane, allyltrimethoxysilane, methyltrimethoxysilane, methyltriethoxysilane, methyl tripropoxysilane, propylethyltrimethoxysilane, phenylmethyldiethoxysilane, trimethylethoxysilane, dimethyldiethoxysilanesilane, vinyltriethoxysilane, allyltriethoxysilane, methyltriethoxysilane, methyl tripropoxysilane, propylethyltrimethoxysilane, ethyltriethoxysilane, vinyltrimethoxysilane, vinyltriethoxysilane, among others.

If also fourth compound is provided along with the first, second and third compounds, the fourth compounds is different from the third compound.

Though the polymerization of the first and second compounds can be performed using an acid catalyst, a base catalyst is preferred. The base catalyst used in a base catalyzed polymerization between the first and second compounds can be any suitable basic compound. Examples of these basic compounds are any amines like triethylamine and any barium hydroxide like barium hydroxide, barium hydroxide monohydrate, barium hydroxide octahydrate, among others. Other basic catalysts include magnesium oxide, calcium oxide, barium oxide, ammonia, ammonium perchlorate, sodium hydroxide, potassium hydroxide, imidazone or n-butyl amine. In one particular example the base catalyst is Ba(OH)₂. The base catalyst can be provided, relative to the first and second compounds together, at a weight percent of less than 0.5%, or at lower amounts such as at a weight percent of less than 0.1%.

Polymerization can be carried out in melt phase or in liquid medium. The temperature is in the range of about 20 to 200° C., typically about 25 to 160° C., in particular about 40 to 120° C. Generally, polymerization is carried out at ambient pressure and the maximum temperature is set by the boiling point of any solvent used. Polymerization can be carried out at refluxing conditions. Other pressures and temperatures are also possible. The molar ratio of the first compound to the second compound can be 95:5 to 5:95, in particular 90:10 to 10:90, preferably 80:20 to 20:80. In a preferred example, the molar ratio of the first compound to the second compound (or second plus other compounds that take part in the polymerization reaction—see below) is at least 40:60, or even 45:55 or higher.

In one example, the first compound has —OH groups as reactive groups and the second compound has alkoxy groups as reactive groups. Preferably, the total number of —OH groups for the amount of the first compound added is not more than the total number of reactive groups, e.g. alkoxy groups in the second compound, and preferably less than the total number of reactive groups in the second compound (or in the second compound plus any other compounds added with alkoxy groups, e.g. an added tetramethoxysilane or other third compound involved in the polymerization reaction, as mentioned herein). With the alkoxy groups outnumbering the hydroxyl groups, all or substantially all of the —OH groups will react and be removed from the siloxane, such as methanol if the alkoxysilane is a methoxysilane, ethanol if the alkoxysilane is ethoxysilane, etc. Though the number of —OH groups in the first compound and the number of the reactive groups in the second compound (preferably other than —OH groups) can be substantially the same, it is preferably that the total number of reactive groups in the second compound outnumber the —OH groups in the first compound by 10% or more, preferably by 25% or more. In some embodiments the number of second compound reactive groups outnumber the first compound —OH groups by 40% or more, or even 60% or more, 75% or more, or as high as 100% or more. The methanol, ethanol or other by-product of the polymerization reaction depending upon the compounds selected, is removed after polymerization, preferably evaporated out in a drying chamber.

The siloxane polymer is first provided in the form of a prepolymer, having a weight average molecular weight, such as from 500 to 5,000 g/mol, such as 750 to 3,000 g/mol.

Upon curing, the molecular weight is typically up to 200,000 g/mol.

In one particular embodiment, the curable polymer is a siloxane prepolymer having a molecular weight (M_{w}) of 500 to 2500 g/mol, and the siloxane prepolymer preferably exhibits one or several reactive groups in particular selected from epoxy, glycidyl, vinyl, allyl, acrylate and methacrylate and combinations thereof.

In one embodiment, the curable monomers are selected from compounds having crosslinkable reactive groups, such as epoxy, glycidyl, vinyl, allyl, acrylate and methacrylate and combinations thereof.

Example of these monomers are methyl acrylate, ethyl acrylate, 2-ethylhexyl (meth) acrylate, hydroxyethyl (meth) acrylate, butyl (meth) acrylate, pentaerythritol tetraacrylate, trimethylolpropane triacrylate, ethylene diacrylate, tetra(ethylene glycol) diacrylate, ethyl 2-cyano acrylate, 2-hydroxyethyl acrylate, isobornyl acrylate, 4-hydroxy butyl acrylate, 2-hydroxyethyl acrylate, 2-Carboxyethyl acrylate, Trimethylolpropane (EO)n Triacrylate, Caprolactone Acrylate, Polypropylene glycol Monomethacrylate, Cyclic trimethylolpropane formal Acrylate, Phenoxy benzyl Acrylate, 3,3,5-trimethyl cyclohexyl Acrylate, Isobornyl Acrylate, o-phenylphenol EO Acrylate, 4-tert-butylcyclohexyl acrylate, Benzyl Acrylate, Benzyl Methacrylate, Biphenylmethyl Acrylate, Lauryl Acrylate, Lauryl Methacrylate, Tridecyl Acrylate, Lauryl Tetradecyl Methacrylate, Isodecyl Acrylate, Isodecyl Methacrylate, Phenol (EO) Acrylate, Phenoxyethyl Methacrylate, Phenol (EO)2 Acrylate, Phenol (EO)4 Acrylate, Tetrahydrofurfuryl Acrylate, Tetrahydrofurfuryl Methacrylate, Nonyl Phenol (PO)2 Acrylate, Nonyl Phenol (EO)4 Acrylate, Nonyl Phenol (EO)8 Acrylate, Ethoxy ethoxy ethyl Acrylate, Stearyl Acrylate, Stearyl Methacrylate, Methoxy PEG600 Methacrylate, 1,6-Hexanediol Diacrylate, 1,6-Hexanediol Dimethacrylate, 1,6-Hexanediol (EO)n Diacrylate, Polypropylene glycol 400 Diacrylate, 1,4-Butanediol Dimethacrylate, Polypropylene glycol 700 (EO)6 Dimethacrylate, 1,6-Hexanediol (EO)n Diacrylate, Hydroxy pivalic acid neopentyl glycol Diacrylate, Bisphenol A (EO)10 Diacrylate, Bisphenol A (EO)10 Dimethacrylate, Neopentyl glycol Dimethacrylate, Neopentylglycol (PO)2 Diacrylate, Tripropylene glycol Diacrylate, Ethylene glycol Dimethacrylate, Dipropylene glycol Diacrylate, Bisphenol A (EO)30 Diacrylate, Bisphenol A (EO)30 Dimethacrylate, Diethylene glycol Dimethacrylate, Triethylene glycol Diacrylate, Triethylene glycol Dimethacrylate, Tetraethylene glycol Dimethacrylate, Bisphenol A (EO)4 Diacrylate, Bisphenol A (EO)4 Dimethacrylate, Bisphenol A (EO)3 Diacrylate, Bisphenol A (EO)3 Dimethacrylate, 1,3-Butylene glycol Dimethacrylate, Tricyclodecane dimethanol Diacrylate, Tetraethylene glycol Diacrylate, Polyethylene glycol 400 Diacrylate, Polyethylene glycol 400 Dimethacrylate, Polyethylene glycol 200 Diacrylate, Polyethylene glycol 200 Dimethacrylate, Polyethylene glycol 300 Diacrylate, Polyethylene glycol 600 Diacrylate, Polyethylene glycol 600 Dimethacrylate, Bisphenol F (EO)4 Diacrylate, Trimethylolpropane Triacrylate, Trimethylolpropane Trimethacrylate, Trimethylolpropane (EO)3 Triacrylate, Trimethylolpropane (EO)15 Triacrylate, Trimethylolpropane (EO)6 Triacrylate, Trimethylolpropane (EO)9 Triacrylate, Glycerine (PO)3 Triacrylate, Pentaerythritol Triacrylate, Trimethylolpropane (PO)3 Triacrylate, Tris(2-hydroxyethyl)isocyanurate Triacrylate, Pentaerythritol (EO)n Tetraacrylate, Ditrimethylolpropane Tetraacrylate, Pentaerythritol Tetraacrylate, Dipentaerythritol Pentaacrylate, Dipentaerythritol Hexaacrylate, to mention a few.

In one embodiment, the curable polymers and monomers are cured by free radical curing.

Typically, the monomers and polymers are curable by photopolymerization using active energy rays such as visible rays, electron beams and, in particular ultraviolet rays (UV).

In embodiments of the present technology, the compositions further contain at least photo-polymerization initiator(s), and optionally coinitiators, such as spectral sensitizer(s), and optionally reducing agents.

In one embodiment, the composition comprises a photopolymerization initiator or combinations thereof, in particular a UV initiator or a combination of UV initiators, for achieving curing of the curable polymer. Examples of the photopolymerization and UV initiators include the following: carbonyl compounds such as aromatic ketones; acylphosphine oxide compounds; aromatic onium salt compounds; organic peroxides; thio compounds; hexaarylbiimidazoles; ketoxime esters; borates compound, azinium compounds; as well as metallocene compounds, active ester compounds and alkylamine compounds.

In one embodiment, ketoxime esters are used as photopolymerization initiators.

Typically, the content of the photopolymerization or UV initiator is 0.1 to 25% by weight, in particular 0.5 to 20% by weight, such as 0.5 to 10% by weight of the composition.

The composition preferably comprises additives capable of adjusting properties of the composition. Such additives can be selected from the group of additives capable of adjusting wetting, adhesion, thixotrophy, foaming properties of the composition, as well as and combinations thereof. Typically, the concentration of the additives is 0.01 to 15%, in particular about 0.1 to 10% of the total weight of the composition, including any solvent.

In one embodiment, the composition comprises a solvent for the curable polymer. The solvent may optionally be selected such that it is also capable of dissolving the black pigment, in particular when organic black pigments are being used.

In one embodiment, the solvent primarily dissolves the curable polymer whereas the nanoparticles and the black pigment are dispersed in the liquid phase rather than dissolved therein.

The dynamic viscosity, at 25° C., of the composition is generally in the range of 5 mPas-1,000,000 mPas or 5 mPas-500,000 mPas, for example about 50 to 50,000 mPas or about 100 to 200,000 mPas, in particular 200 to 100,000 mPas, such as 250 to 10,000 mPas, determined by a rheometer at 2.5 s⁻¹ shear rate.

For application, the viscosity of the composition can be adjusted for example by adjusting the solids content of the composition. Generally, the solids content is in the range of 10 to 100% by weight, in particular about 30 to 100% by weight, for example 40 to 100% by weight, or 60 to 100% by weight, in particular 80 to 100% by weight, of the total composition.

In one embodiment, the viscosity of the composition is adjusted by adjusting the amount of solvent for the curable polymer. Thus, the viscosity can be adjusted by adding 10 to 200 parts by weight of a liquid capable of dissolving the curable polymer to 100 parts of solids, formed by polymer, nanoparticles and black pigments.

The solvent is, for example, selected from the group of organic solvents, such as ketones, ethers, alcohols and esters. As specific examples the following can be mentioned: acetone, tetrahydrofuran (THF), toluene, methanol, ethanol, 2-propanol, propylene glycol monomethyl ether, methyl-tert-butylether (MTBE), propylene glycol propyl ether, propylene glycol propyl ether (PnP), propyleneglycolmonomethylether acetate (PGMEA) and propyleneglycolmonomethylether PGME.

In one embodiment, propyleneglycolmonomethylether acetate (abbreviated “PGMEA”) is being used.

In one embodiment, the viscosity of the composition is adjusted by adjusting the amount of monomer. This allows for the provision of solvent free compositions having a predetermined viscosity. More specifically, in one embodiment, 50 to 100% of the curable components of the coating is provided by a monomer in the composition, the percentage being calculated from the total weight of the curable components, in particular the polymer(s) and monomer(s).

In one embodiment, compositions for producing coatings having a RI of 1.9 or more, 80 to 100% of the curable components of the coating is provided by a monomer in the composition.

In one embodiment, a composition for coating of optical substrates is provided by the steps of
adding to curable monomer(s) and any curable polymer(s) metal oxide nanoparticles in a liquid phase to provide a mixture,
evaporating off at least a part of or all the liquid phase, and
adding black pigment, curing catalyst and additives to the mixture

The mixture of polymer and monomers and nanoparticles is typically a viscous fluid or syrup after the evaporation of the solvent.

In one embodiment, the black pigment is added to a mixture formed by the other components to form a modified mixture, which is then subjected to milling to disperse or dissolve the black pigment.

In one embodiment, during the preparation of the composition, aggregation of the black pigment is prevented.

The composition can be applied onto a surface of a substrate by a number of application methods.

In one embodiment, the application method is selected from the group consisting of contact-free or contacting methods, in particular from the group of dispensing, spraying, slit-coating, spin-coating, doctor blade coating, curtain coating, contact-free or contacting painting and printing, such as flexo or screen printing.

The composition is then cured by subjecting it to photo-curing using for example UV light to form a cured film. As a result, the polymer and the monomers cure and form a cross-linked network on the surface. This polymer matrix adheres to the surface and binds the nanoparticles and the black pigments thereto.

The UV light used for achieving photo-curing typically exhibits peaks in the range from 250 nm to 450 nm, and when using single wavelength UV light sources, such as LEDs, the wavelength is typically selected from one or several of the following: 285 nm, 300 nm, 310 nm, 365 nm, 385 nm, 395 nm, and 405 nm. The energy dose of the UV light is, according to one embodiment, in the range of 1 to 500 J/cm², such as 5 to 100 J/cm², for example 10 to 50 J/cm².

In one embodiment, the composition is used for high refractive index edge-blackening of a high refractive index material. Typically, the high refractive index material comprises a glass substrate, in particular a glass substrate, having a non-polished rough surface onto which the composition is coated.

By application of the composition in solvent free form, no or essentially no solvent is evaporated during curing. As a result, a uniform film is formed on the surface which gives even distribution of the nanoparticles and black pigments on the surface.

The following non-limiting example illustrates some embodiments.

### EXAMPLES

### Synthesis of Siloxane Polymer:

A 500 mL round bottom flask with stirring bar and reflux condenser was charged with diphenylsilanediol (60 g, 45 mol %), [3-(Methacryloyloxy)propyl]trimethoxysilane (55.12 g, 36.7 mol %) and tetramethoxysilane (17.20 g, 18.3 mol %). The flask was heated to 80° C. under nitrogen atmosphere and 0.08 g of barium hydroxide monohydrate dissolved in 1 mL of methanol was added dropwise to the mixture of silanes. The silane mixture was stirred at 80° C. for 30 min during which time the diphenylsilanediol reacted with alkoxysilanes. After 30 min, the formed methanol was evaporated off under vacuum. The siloxane polymer had viscosity of 1200 mPas and M_{w} of 1200 g/mol.

### Forming of Compositions:

The siloxane polymer of the preceding step was mixed with curable monomer and the TiO₂ nanoparticle solution in PGMEA to achieve a predetermined ratio between polymer and nanoparticles. The solvent was evaporated off under vacuum using rotavapor and curing catalyst, additive and black absorbing pigment were added and the formulation was mixed thoroughly. Finally, the composition is milled using three-roll-mill to obtain a homogeneous mixture.

Six different formulations were made (Formulations 1-6) with tree different nanoparticle loadings and two TiO₂ nanoparticle types (Nanoparticle A with Z-average of 37 nm and Nanoparticle B with Z-average of 81 nm). The compositions by weight percentage are mentioned in Table 1.

The refractive index of the formulations was measured from the formulation before adding the black absorbing pigment. Samples of the siloxane polymer and nanoparticle solution were spin coated on silicon wafer and cured by 405 nm UV-LED and dose of 20 J/cm². The refractive index was measured with ellipsometer (Woollam alpha-SE) at a wavelength of 589 nm. The viscosities of the final formulations were measured with rheometer at 10 l/s shear rate.

TABLE 1

| | Formulation | Formulation | Formulation | Formulation | Formulation | Formulation |
|---|---|---|---|---|---|---|
| Component | 1 | 2 | 3 | 4 | 5 | 6 |
| Siloxane | 9 | 9 | 4 | 9 | 9 | 4 |
| polymer | | | | | | |
| TiO₂ - | 56 | 70 | 79 | 0 | 0 | 0 |
| nanoparticle A | | | | | | |
| Z-average | | | | | | |
| 36 nm | | | | | | |
| TiO2- | 0 | 0 | 0 | 56 | 70 | 79 |
| nanoparticle B | | | | | | |
| Z-average | | | | | | |
| 81 nm | | | | | | |
| Monomer | 21 | 7 | 3 | 21 | 7 | 3 |
| Biphenylmethyl | | | | | | |
| Acrylate | | | | | | |
| Additive | 8 | 8 | 8 | 8 | 8 | 8 |
| Hydroxyethyl | | | | | | |
| methacrylate | | | | | | |
| Carbon black | 2 | 2 | 2 | 2 | 2 | 2 |
| Initiator | 4 | 4 | 4 | 4 | 4 | 4 |
| OXE-02 | | | | | | |
| Properties | | | | | | |
| Viscosity, mPas | 537 | 7 732 | Dry | 154 | 7 199 | 113 910 |
| Refractive | 1.80 | 1.87 | — | 1.92 | 1.95 | 2.00 |
| index | | | | | | |
| at 589 nm | | | | | | |

The results shows that the particle size of the TiO₂ is essential in controlling both viscosity and refractive index of the formulation in the solvent free state. With smaller TiO₂ particle size the formulations have higher viscosity than formulations with the larger particle size.

With the highest nanoparticle loading (formulations 3 and 6), the smaller nanoparticle formulation is a dry and viscosity cannot even be measured.

Another finding is also the refractive index of the formulations. Larger particle size TiO₂ nanoparticles gives higher refractive indices than the same formulation with the smaller particle size nanoparticles. In the formulation, the small particles sizes are favoured due to lower scattering cross-sections, leading to better performance. The scattering by large nanoparticles will contribute to the reflectance at the optical substrate—coating interface by giving rise to diffuse reflectance.

Another set of compositions is made by varying the used black pigment/filler. Formulations from 7 to 11 were made similarly to formulation 1, but the pigment type/filler was changed. Three different carbon black powders were tested: Furnace black 47250 by Kremer pigment, MA11 carbon black by Mitsubishi Chemical Corporation (average particle size 29 nm), M1100 carbon black made by Cabot (surface treated for improved dispersibility). One black pigment X55 was tested from BASF and also PGMEA dispersion of MA11 was manufactured by rock milling the MA11 with 30 weight-% of PX4310 manufactured by Efka in PGMEA solution (total solid content of 20%). For the MA11 dispersion the carbon black was added before the solvent evaporation step to remove the excess PGMEA from the dispersion. The compositions of formulations 7 to 11 by weight percentage are shown in Table 2.

TABLE 2

| | Formula- | Formula- | Formula- | Formula- | Formula- |
|---|---|---|---|---|---|
| Component | tion 7 | tion 8 | tion 9 | tion 10 | tion 11 |
| Siloxane | 9 | 9 | 9 | 9 | 9 |
| polymer | | | | | |
| TiO₂ - | 56 | 56 | 56 | 56 | 56 |
| nanoparticle | | | | | |
| A Z-average | | | | | |
| 36 nm | | | | | |
| Monomer | 21 | 21 | 21 | 21 | 21 |
| Biphenyl- | | | | | |
| methyl | | | | | |
| Acrylate | | | | | |
| Additive | 8 | 8 | 8 | 8 | 8 |
| Hydroxy- | | | | | |
| ethyl | | | | | |
| methacrylate | | | | | |
| Furnace | 2 | 0 | 0 | 0 | 0 |
| black 47250 | | | | | |
| Mitsubishi | 0 | 2 | 0 | 0 | 0 |
| MA11 | | | | | |
| Cabot | 0 | 0 | 2 | 0 | 0 |
| M1100 | | | | | |
| Mitsubishi | 0 | 0 | 0 | 2 | 0 |
| MA11- | | | | | |
| PGMEA | | | | | |
| dispersion | | | | | |
| X55 black | 0 | 0 | 0 | 0 | 2 |
| pigment | | | | | |
| Initiator | 4 | 4 | 4 | 4 | 4 |
| OXE-02 | | | | | |

For reflectance studies, the formulations were applied as a 60 μm layer on a high RI glass substrate (RI 1.8 at 589 nm) by doctor blading. After application as a thin film, the films were cured by UV using 405 nm UV-LED with UV dose of 20 J/cm². Curing of the formulation results in a reflective smooth black surface against the air surface.

The functioning of the formulations as an edge-blackening material is shown by measuring the reflectance from the interface between the high refractive index glass and the formulations 7 to 11. The reflectance was measured using Konica Minolta CM-3600A spectrophotometer, which utilizes an integrating sphere and can measure diffuse and total reflectance. The incidence angle of the light is 8°. The sample was placed to the equipment with the non-coated glass side towards the light beam. It should be noted that in this setup the measurement of the reflectance of the glass-coating interface is not possible without the reflectance from the air-glass interface, which is why this reflection is corrected from the reflectance data as follows.

Firstly, the reflectance of the clean substrate is measured. The reflectance of the substrate, R, is assumed to have only a specular component. The clean substrates have two identical surfaces with reflectivity r₁ and the resulting measured reflectance can be approximated to result from the reflectivity as

$$R = {r}_{1} + {r}_{1} \cdot {( 1 - {r}_{1} )}^{2} + {r}_{1}^{3} \cdot {( 1 - {r}_{1} )}^{2} .$$

The single interface reflectivity is calculated with the former equation from the measured substrate data.

With the reflectivities of air-glass interface, r₁ and glass-coating interface, r₂, the reflectance with the sample coating can be approximated as

$${R}_{s a m p l e} = {r}_{1} + {r}_{2} \cdot {( 1 - {r}_{1} )}^{2} .$$

$${r}_{2} = \frac{{R}_{s ample} - {r}_{1}}{{( 1 - {r}_{1} )}^{2}} .$$

The measured diffuse reflection component is multiplied by a simplified correction factor (1−r₁)⁻², which corrects for the intensity loss of the incident light at air-glass interface, and the reflection of the scattered light at the glass-air interface. The correction for the reflection of scattered light is simplified by using the same reflectivity of the air-glass interface as measured for 8° incidence angle, which underestimates the correction.

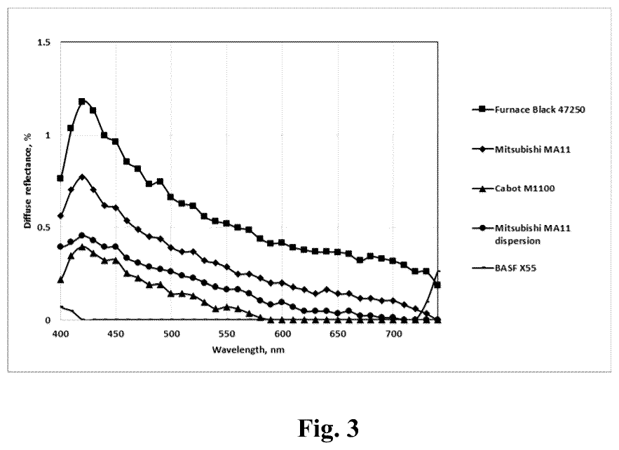

The calculated reflectivity values of glass-coating interfaces, r₂, are shown in FIG. 2 (total reflectance) and FIG. 3 (diffuse reflectance). The reference value for non-coated glass is reflectivity r₁.

The results show that the black pigment/filler has a big impact for the total reflectance and especially to the diffuse reflectance, which is included in the total reflectance value. This shows how much the scattering caused by black pigment filler affects the performance of the edge blackening material. The measurement shows that with the minimized difference in refractive index, the diffuse reflectance accounts for most of the total reflectance.

Lowest total and specular reflectance are obtained with X55 black pigment which dissolves to the resin system, and therefore, the scattering from the black pigment is very low. Second lowest total and specular reflectance's are obtained with Cabot M1100 carbon black which is surface treated for improved dispersability. Mitsubishi MA11 shows clear improvement in diffuse reflectance when the carbon black is dispersed in PGMEA using dispersant but in total reflectance the results are higher than MA11 used as powder. Higher reflectances are obtained with untreated high particle size carbon black 47250 where the light scattering can be big between the resin and black fillers.

1. A black coating comprising:
a cured solid film formed from a curable composition mixed with metal oxide nanoparticles and black pigment, said cured solid film having a metal oxide nanoparticle weight percentage greater than 45%.

2. The black coating according to claim 1, wherein the film has a refractive index of more than 1.75, said refractive index being measured at 589 nm.

3. The black coating according to claim 1, wherein said film has a thickness of 1 to 300 μm.

4. The black coating according to claim 1, wherein the film has an optical density of more than 2, at wavelengths between 400 and 740 nm.

5. The black coating according to claim 1, wherein the metal oxide nanoparticles are selected from the group consisting of titanium dioxide, zirconium dioxide, hafnium dioxide, aluminium oxide, germanium dioxide, barium titanate, niobium oxide, and combinations thereof, the nanoparticles having a Z-average particle diameter of 1 to 200 nm.

6. The black coating according to claim 1, wherein the black coating has a refractive index, and wherein a complex part of the refractive index is lower than 0.05.

7. The black coating according to claim 1, wherein the photocurable composition comprises curable components, and wherein the weight ratio of the metal oxide nanoparticles to the curable components amounts to from 95:5 to 50:50.

8. The black coating according to claim 1, wherein the black pigment is selected from the group consisting of soot, carbon black, carbon nanotubes, graphite, organic pigments, metal complex dyes, metal oxide particles, and combinations thereof.

9. The black coating according to claim 1, wherein the black pigment is selected to obtain a black coating with a diffuse reflectance lower than 1.5%.

10. The black coating according to claim 1, wherein the film is disposed on an optical substrate, and wherein the refractive index of the film differs no more than ±0.4 units from that of the optical substrate, said refractive index being measured at 589 nm.

11. The black coating according to claim 1, wherein the film is deposited on an optical substrate or a stack of optical substrates having a refractive index of more than 1.75.

12. The black coating according to claim 1, wherein the total reflection at an interface between the optical substrate and the coating film is less than 2% at 400-740 nm.

13. The black coating according to claim 1, wherein the composition is cured by photo-activation.

14. The black coating according to claim 1, wherein the photocurable composition comprises:
0 to 50 parts by weight of a curable polymer;
curable monomers in an amount of up to 50 parts by weight;
50 to 100 parts by weight of metal oxide nanoparticles; and
0.1 to 20 parts by weight of black pigment;
said metal oxide nanoparticles and black pigment being mixed with the curable polymer and curable monomers.

15. The black coating according to claim 1, wherein:
the curable polymer exhibits one or several reactive groups selected from the group consisting of epoxy, glycidyl, vinyl, allyl, acrylate, methacrylate and combinations thereof, and wherein the curable polymer comprises a prepolymer having a molecular weight (M_{w}) of 500 to 2,500 g/mol; and
the curable monomers are selected from compounds having crosslinkable reactive groups selected from the group consisting of epoxy, glycidyl, vinyl, allyl, acrylate, methacrylate, and combinations thereof.

16. A composition for coating an optical substrate, the composition comprising:
0 to 50 parts by weight of a curable polymer;
curable monomers in an amount of up to 50 parts by weight;
50 to 100 parts by weight of metal oxide nanoparticles; and
0.1 to 20 parts by weight of black pigment;
said metal oxide nanoparticles and black pigment being mixed with the curable polymer and curable monomers.

17. The composition according to claim 16, wherein the curable polymer is selected from prepolymers having a molecular weight (M_{w}) of 500 to 100,000 g/mol and exhibiting one or several reactive groups selected from the group consisting of epoxy, glycidyl, vinyl, allyl, acrylate, hydride, thiol, methacrylate and combinations thereof.

18. The composition according to claim 16, wherein the curable monomers exhibit one or several reactive groups selected from the group consisting of epoxy, glycidyl, vinyl, allyl, acrylate, hydride, thiol, methacrylate and combinations thereof.

19-20. (canceled)

21. The composition according to claim 16, comprising black pigment in concentration of 0.1 to 10%, calculated from the total weight of the composition excluding solvent.

22. The composition according to claim 16, wherein the composition further comprises a solvent to modify the viscosity of the composition, said solvent optionally also being capable of dissolving the black pigment.

23. The composition according to claim 16, wherein the solids content of the composition is 60 to 100% by weight, and wherein a remainder of the composition comprises a solvent.

24. The composition according to claim 16, wherein the composition further comprises 0.1 to 25% of the total weight of the composition of a photopolymerization initiator or a combination of photopolymerization initiators.

25. The composition according to claim 16, wherein the composition further comprises one or more additives capable of adjusting properties of the composition, and wherein the properties are selected from the group consisting of wetting, adhesion, thixotrophy, foaming, and combinations thereof.

26. The composition according to claim 16, wherein the composition has a dynamic viscosity of 5 mPas-1,000,000 mPas at 25° using a rheometer at 10 s⁻¹ shear rate.

27. The composition according to claim 16, comprising
1 to 15 parts by weight of the curable polymer;
10 to 40 parts by weight of the curable monomers;
50 to 100 parts by weight of the metal oxide nanoparticles;
0.1 to 20 parts by weight of the black pigment; and optionally
0.1 to 50% of a solvent, calculated from the total weight of the composition.

28. The composition according to claim 16, the composition comprising less than 5% of a solvent, calculated from the total weight of the composition.

29. An optical substrate comprising a black coating according to claim 1.

30-34. (canceled)
